(19) United States
(12) Patent Application Publication
(10) Pub. No.: US 2026/0236837 A1
(43) Pub. Date: Aug. 13, 2026

(54) SYSTEMS AND METHODS FOR GENERATING A MACHINE LEARNING DRIVEN REGRESSIVE FORECASTING MODEL OPTIMIZED FOR A USER DECLARED LIGHTWEIGHT DATASET

(71) Applicant: JPMorgan Chase Bank, N.A., New York, NY (US)

(72) Inventors: Brandon Sharp, Chicago, IL (US); Kirti Verma, Mumbai (IN); Danielle Wang, Chicago, IL (US); Ruchi Bahl, London (GB); Dominic Yang, Dallas, TX (US)

(73) Assignee: JPMorgan Chase Bank, N.A., New York, NY (US)

(21) Appl. No.: 19/173,318

(22) Filed: Apr. 8, 2025

(30) Foreign Application Priority Data
Feb. 12, 2025 (IN) 202511011786

(51) Int. Cl. G06N 20/00

(52) U.S. Cl. CPC G06N 20/00

(57) ABSTRACT

Aspects of the subject disclosure may include, for example, enabling a user to select one or more features and one or more targets, training different artificial intelligence/machine learning (AI/ML) models in a pool of AI/ML models with training data relevant to the selected one or more features and the selected one or more targets, selecting a best AI/ML model among the trained different AI/ML models based on predetermined evaluation criteria, and generating, using the selected best AI/ML model, a forecast result for each of the selected one or more targets. Other embodiments are disclosed.

### CROSS REFERENCE TO RELATED APPLICATIONS

This application claims priority to Indian patent application Ser. No. 202511011786 filed on Feb. 12, 2025. All sections of the aforementioned application are incorporated herein by reference in their entirety.

### FIELD OF THE DISCLOSURE

The subject disclosure relates to systems and methods for generating a machine learning driven regressive forecasting model optimized for a user declared lightweight dataset.

### BACKGROUND

Financial enterprises such as banks may constantly need to forecast operations. Due to limited and volatile nature of available data, many departments within financial enterprises often encounter difficulties and uncertainty in forecasting and prediction of monthly volumes, etc. Traditional forecasting methods may not be sufficiently reliable when huge datasets are required for training. Relying on historical volume data solely to make forecasts may result in undesirable errors, specifically for smaller datasets. Furthermore, complexity of advanced machine learning techniques may require technicians or engineers with extensive coding knowledge to develop or utilize machine learning tools, thereby limiting available personnels for forecasting tasks. It is desirable to have a more accessible and efficient tool that can handle advanced machine learning tasks without requiring extensive coding knowledge and experience.

### SUMMARY OF THE DISCLOSURE

The subject disclosure describes, among other things, illustrative embodiments for systems and methods for generating a machine learning driven regressive forecasting model optimized for a user declared lightweight dataset. The systems and methods are tailored for lightweight, small data environments and a declarative AI framework, which handle the complexities of model building and optimization without user intervention. The systems and methods allow for streamlined model development, making it easier and faster to generate accurate forecasts based on limited data, particularly for monthly interval datasets.

The systems and methods enable users to build, optimize, and deploy robust forecasting machine learning models through automation, thereby requiring no extensive coding expertise and knowledge. The systems and methods implement an interface that makes advanced machine learning accessible to users without requiring coding expertise. The interface allows users to upload data, select features, and define targets with a simple process such as a few clicks. The systems and methods automate underlying processes, including data preparation, feature engineering, and model optimization, ensuring that even those with limited technical knowledge can build and deploy high-performance forecasting models. The interface may be standardized and configured to be compatible in various use cases. Other embodiments are described in the subject disclosure.

One or more aspects of the subject disclosure are directed to a method including, in response to a dataset received from a user machine, presenting, by a processing system including a processor, a feature set and a target prediction set to a user interface of a user machine, receiving, by the processing system, from the user machine, a selection of one or more features of the feature set and one or more target predictions of the target prediction set, in a pool of artificial intelligence/machine learning (AI/ML) models, training, by the processing system, every AI/ML model with respect to the received selection of the one or more features, selecting, by the processing system, a best AI/ML model among the trained AI/ML models based on model performance evaluation criteria, and generating, by the processing system, a forecast result for each target prediction using the best AI/ML model.

One or more aspects of the subject disclosure are directed to a non-transitory machine-readable medium, comprising executable instructions that, when executed by a processing system including a processor, facilitate performance of operations. The operations include enabling a user to select one or more features and one or more targets, for the selected one or more targets, training different artificial intelligence/machine learning (AI/ML) models in a pool of AI/ML models with training data relevant to the selected one or more features, selecting a best AI/ML model among the trained different AI/ML models based on predetermined evaluation criteria, and generating, using the selected best AI/ML model, a forecast result for each of the selected one or more targets.

One or more aspects of the subject disclosure are directed to a device including a processing system including a processor, and a memory that stores executable instructions that, when executed by the processing system, facilitate performance of operations. The operations include, in response to datasets provided by a user, automating correlation between a set of features and a set of targets and populating the correlation for display on a user machine; receiving, from the user machine, a selection of one or more features in the set of features, and a selection of one or more targets in the set of targets; automating data preparation of the datasets provided by the user; training a plurality of artificial intelligence/machine learning (AI/ML) models in a pool of AI/ML models with the selected one or more features; selecting a best AI/ML model among the trained AI/ML models based on predetermined model performance criteria; training the selected best AI/ML model with respect to each of the selected one or more targets; and generating, using the selected and trained best model, forecast results for each of the selected one or more targets.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a system for generating a machine learning driven regressive forecasting model optimized for a user declared dataset in accordance with various aspects described herein.

FIG. 2 depicts an illustrative embodiment of system configurations in accordance with various aspects described herein.

FIG. 3 depicts an illustrative embodiment of a model selection in accordance with various aspects described herein.

FIG. 4 depicts an exemplary, non-limiting embodiment of a first user interface in accordance with various aspects described herein.

FIG. 5 depicts an exemplary, non-limiting embodiment of a second user interface in accordance with various aspects described herein.

FIG. 6 depicts an exemplary, non-limiting embodiment of a third user interface in accordance with various aspects described herein.

FIG. 7 depicts an exemplary, non-limiting embodiment of a fourth user interface in accordance with various aspects described herein.

FIG. 8 depicts an illustrative embodiment of a method for generating a machine learning driven regressive forecasting model optimized using a current dataset in accordance with various aspects described herein.

FIG. 9 depicts an illustrative embodiment of another method for generating a machine learning driven regressive forecasting model optimized using a current dataset in accordance with various aspects described herein.

FIG. 10 depicts an illustrative embodiment of further another method for generating a machine learning driven regressive forecasting model optimized using a current dataset in accordance with various aspects described herein.

FIG. 11 is a block diagram of an example, non-limiting embodiment of a computing environment in accordance with various aspects described herein.

### DETAILED DESCRIPTION

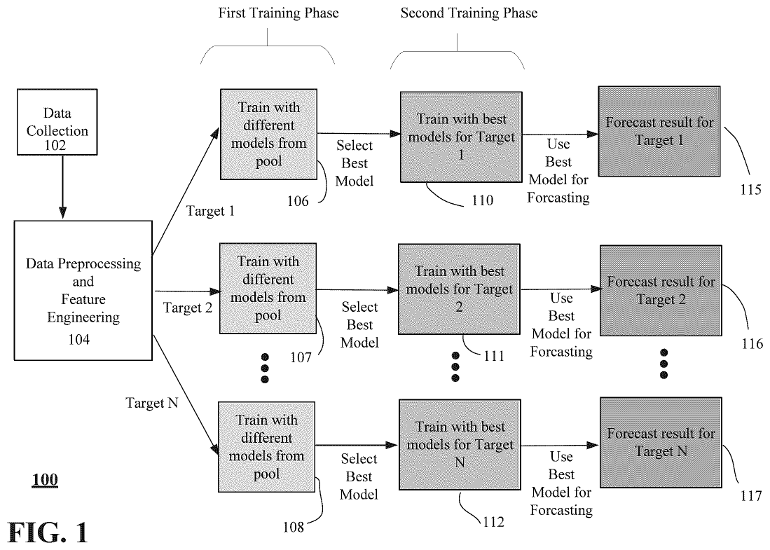

FIG. 1 is a block diagram illustrating an exemplary, non-limiting embodiment of a system 100 for generating a machine learning driven regressive forecasting model optimized using a user declared lightweight dataset in accordance with various aspects described herein. In various embodiments, the system 100 is configured to implement a declarative artificial intelligent (AI) framework. In the declarative AI framework, users declare what users intend to achieve. More specifically, users define predictors as well as targets to be achieved in the declarative AI framework. For instance, users define predicting future sales, forecasting employee workload or headcount needs by predicting future activity volumes, forecasting revenues, expenses, or loan approvals, etc. In response to the defined predictors and targets, the system 100 automates intricate processes of feature engineering, model selection, and then hyperparameter tuning in order to execute the user defined predictors and targets. By automating these processes, the system 100 may reduce potentials for errors and lower a cognitive load, enabling non-experts to achieve accurate results without deep technical knowledge.

Regression analysis is a forecasting tool that uses data and mathematical equations to predict future values based on the relationship between variables. Regression analysis is often used in business analysis and financial analysis to understand how data relates to each other. For example, regression analysis can be used to predict sales based on changes in GDP. Sales regression analysis is used to understand how certain factors in a sales process affect sales performance and predict how sales would change over time if the same strategy continues or different methods apply. Independent and dependent variables are at play here, but the dependent variable is sales performance. The independent variable is the factor users are examining that will change sales performance, like the number of salespeople in the department or how much money is spent on advertising. Sales regression forecasting results help businesses understand how their sales teams are or are not succeeding and what the future could be based on past sales performance. The results can also be used to predict future sales based on changes that have not yet been made.

In various embodiments, the system 100 includes a data collection component 102 and a data preprocessing and feature engineering component 104. The data collection component 102 is configured to receive and collect data from users. The system 100 is designed to build high-performance regressive forecasting models, specifically for environments with monthly or daily data intervals and lightweight, small datasets. By way of example only, lightweight, small datasets may include less than 30 rows for a monthly interval (so for 10 years, 120 months*30 rows), less than 5000 rows for a daily interval, etc. As another example, the scope of datasets may not go back to past 5 or 10 years based on extreme circumstances such as the covid global pandemic which resulted in significant changes to relevant data. The data may be related to or customized to specific subject matter or specific fields or topics based on user's defined predictors and targets as declared. The data may be also related to forecast activities by users. Accordingly, the data collected in the data collection component 102 include a lightweight, small dataset specific to the subject matter or fields such as forecasting future monthly sales volume.

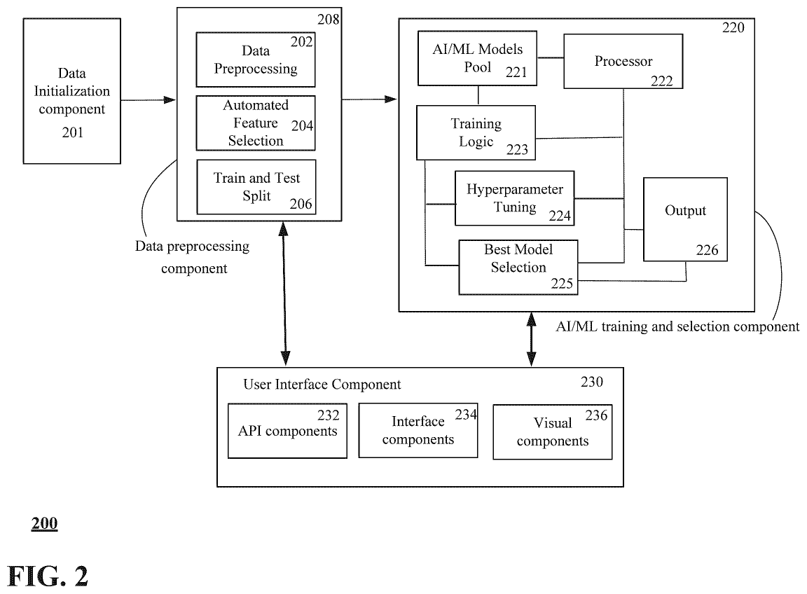

In various embodiments, the data preprocessing and feature engineering component 104 receives the collected data from the data collection component 102 and perform data preprocessing and feature engineering. The data preprocessing and feature engineering are described more in detail below in connection with FIG. 2.

In various embodiments, the system 100 includes a first training phase and a second training phase. With respect to the first training phase, the system 100 further includes one or more training components 106, 107 and 108. As described above, the system 100 is configured and structured to implement predictors and targets as declared by users. Different predictors and targets lead to different forecasting activities, such as Target 1, Target 2, Target N, etc. For instance, workforce planning and volume forecasting, sales forecasting, financial performance prediction, operations efficiency and resource allocation, government and public sector applications are examples of the predictors and targets. As another example, the system 100 can be used in a large organization having various teams such as marketing teams, customer service teams, information technology teams, etc., regardless of whether each team has a different declarative intent or objective.

As depicted in FIG. 1, different targets may trigger training with different models available from and in a pool of artificial intelligence/machine learning (AI/ML) models. The training component 106 trains different AI/ML models from the pool with training data relevant to a dataset and features directed to Target 1, and the training component 107 trains different AI/ML models from the pool with training data relevant to a dataset and features directed to Target 2. As a result of training different AI/ML models, a respective best AI/ML model is selected as to Target 1, Target 2, Target N. For each target, one best AI/ML model may be selected and different best AI/ML models can be selected for different targets.

In various embodiments, with respect to the second training phase, the system 100 further includes second training components 110, 111 and 112. The second training components 110, 111 and 112 train the respective selected best models as a result of the first training phase. After training, the respective selected best models are put to use and operate to generate forecast results. The system 100 includes forecast components 115, 116 and 117, with respect to Target 1, Target 2, and Target N. The forecast components 115, 116 and 117 are configured to generate forecast results with respect to Target 1, Target 2, and Target N. In practical applications, it may be needed to visualize how the selected best model performs, so a certain amount of data (e.g., 6 months minimum) is left to evaluate performance. The selected best model may not be trained on all available data. After the selected best model is selected, it retrains it on all available data (including, for example, the 6 month data previously left out). This enables the system 100 to not only automate reliable testing, but having it automated and ready for immediate production use.

FIG. 2 depicts an illustrative embodiment of a system 200 for generating a machine learning driven regressive forecasting model. In various embodiments, the system 200 includes a data initialization component 201, a data preprocessing component 208, an AI/ML training and selection component 220, and a user interface component 230.

In various embodiments, the data initialization component 201 is configured to collect, store and/or provide data. By way of example, a user works in a sales department and desires to obtain sales forecasting using the system 200. The user intends to use the system 200 to predict future sales based on monthly historical data and market trends, thereby utilizing sales forecasting to help drive inventory decisions, budgeting, and resource allocation. The user can declare such an intent by uploading a relevant data file into the data initialization component 201. For instance, the relevant data file includes monthly historical data and information representing market trends. By way of example, users upload datasets in a particular file format (e.g., a comma separate values (CSV) file). Additionally or alternatively, users may be presented with an option to provide users' declarative intent by inputting intents such as forecasting monthly sales volume.

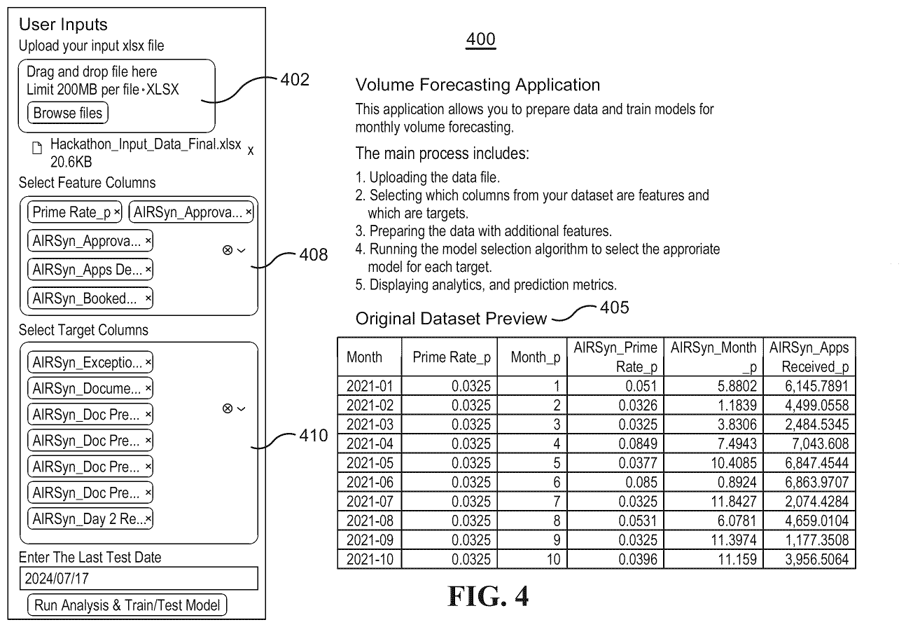

In various embodiments, the user interface component 230 includes an application program interface (API) components 232, interface components 234, and visual components 236. The user interface component 230 may be configured to enable users to input necessary information or data. For instance, the user interface component 230 enables users to upload datasets in certain file formats. FIGS. 4 through 7 illustrate non-limiting examples of the user interface component 230. As depicted in FIG. 4, in order to upload the datasets, users can drag and drop the relevant data file or browse files stored in a storage. As described above, the user interface component 230 can present an input section that allows users to provide users' declarative intent by allowing users to manually input or select from a list of available use cases. The user interface component 230 can be customized to address specific use cases and populate a customized list of available use cases, which can be modified, updated, or added/deleted to change use cases in the listing.

In various embodiments, the data preprocessing component 208 includes a data preprocessing module 202, an automated feature selection module 204 and a train and test split module 206. The data preprocessing module 202 is configured to clean data by handling missing values, remove duplicates, and/or performing outlier detection and treatment in the dataset provided from the data initialization component 201. The data preprocessing module 204 is further configured to perform several functions, including but not limited to, encoding categorical variables, feature scaling, polynomial features, logarithmic features, and data split.

In various embodiments, the automated feature selection module 204 is configured to initially assess the dataset and analyze the dataset. The automated feature selection module 204 is configured to populate a plurality of features and targets which are relevant to the dataset and the user's declarative intent (e.g., forecasting sales volume). The automated feature selection module 204 is configured to provide the populated features and targets based on the user provided dataset to the user interface component 230 in order to generate an immediate preview. FIG. 4 illustrates one example of the preview 405, although the present disclosure is not limited thereto. The preview can be in any format that allows users to easily understand and manipulate content of the preview (e.g., drag and drop, hyperlink, information buttons, etc.).

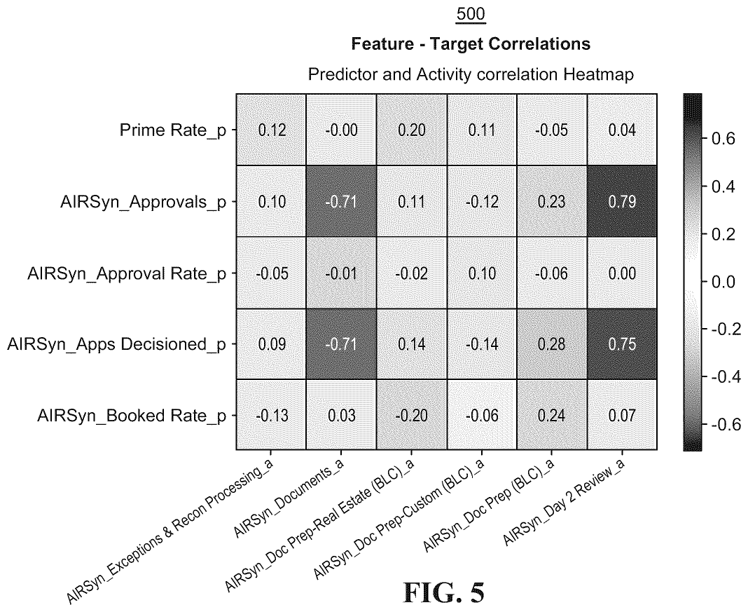

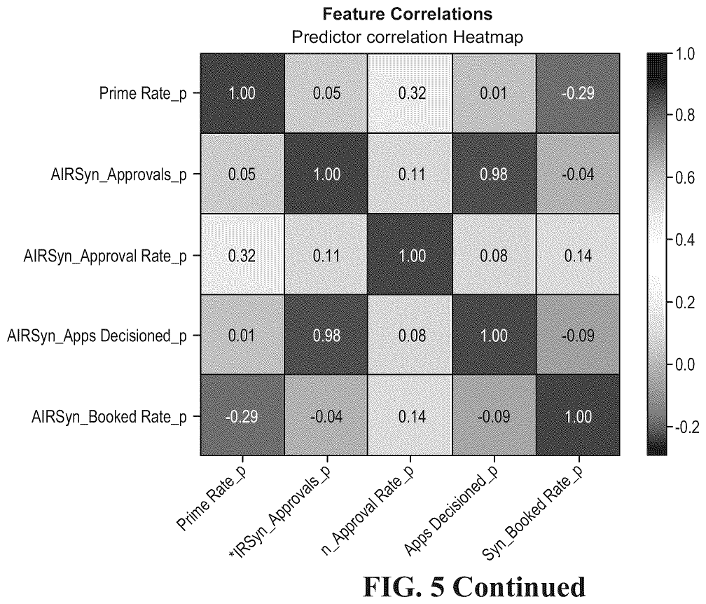

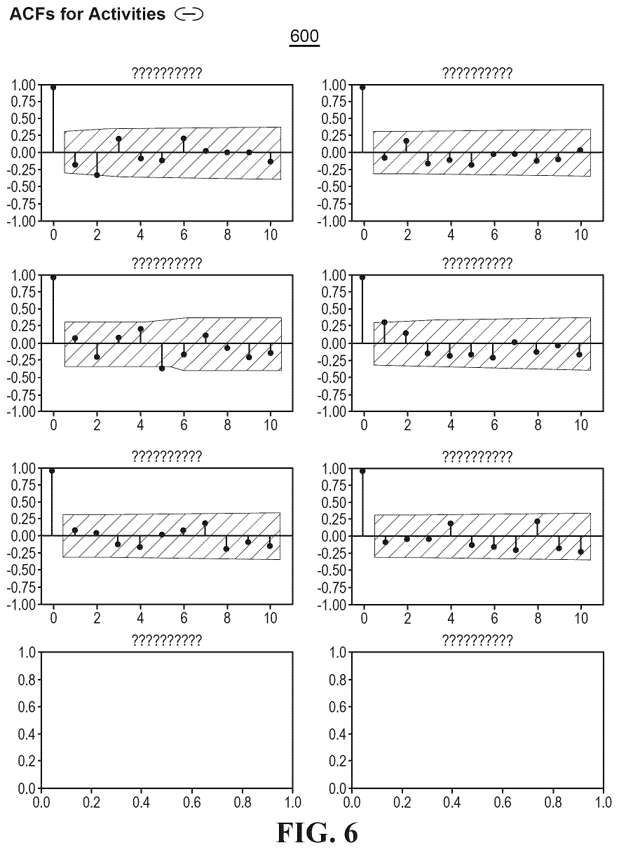

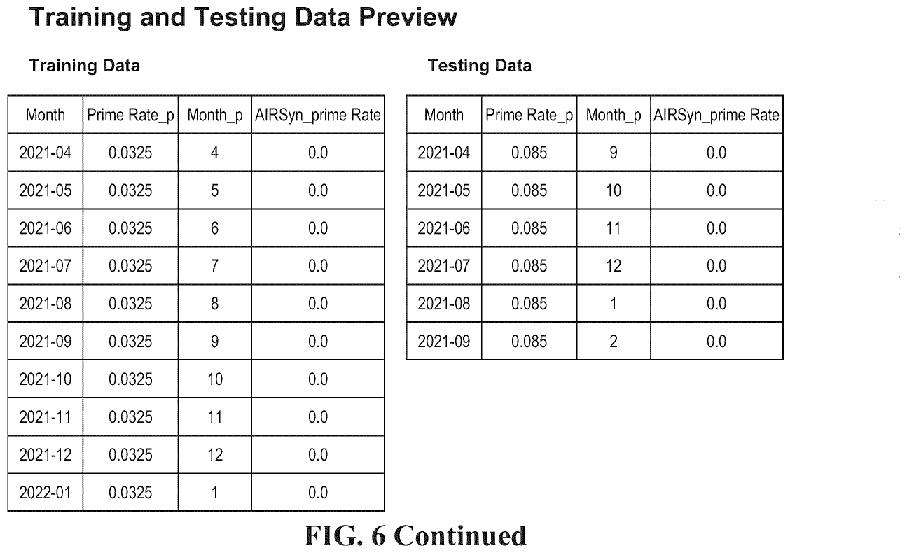

In various embodiments, the automated feature selection module 204 is further configured to generate and display correlation heatmaps and autocorrelation plots. The automated feature selection module 204 provides such correlation heatmaps and autocorrelation plots to the user interface component 230. FIG. 5 depicts a non-limiting example of correlation heatmaps in accordance with various aspects described herein. FIG. 6 depicts a non-limiting example of autocorrelation plots (e.g., ACFs) in accordance with various aspects described herein. The correlation heatmaps provide visual insights into relationships between features and targets. These visual tool help users identify the most relevant features and understand the features' impact on the targets.

In various embodiments, the targets or target variables are dependent variables that users are trying to predict or understand. The targets or target variables are the outcome or result that users are interested in, and it is what users want to learn about using the system 200. If a user is trying to predict the price of a house, a target or a target variable is the sale price of the house. Types of target variables include categorical target variables and numerical target variables. The categorical target variables are known as nominal or qualitative target variables. Numerical target variables are known as continuous or quantitative target variables. The features or feature variables are independent variables, predictors, or input variables. The features or feature variables are the inputs that are used to make predictions about the output. In the house price example, the feature variables can be a square footage of the house, a number of bedrooms and bathrooms, a location of the house, etc. The target variable and feature variables are related to each other in that the feature variables are used to predict or explain the target variable. Using machine learning, the selected model is trying to learn the relationship between the target variable and the feature variables so that accurate predictions can be made about the target variable for new data points. As described above, target and feature variables define the problem that users are trying to solve and help to guide the selection of appropriate machine learning algorithm.

In various embodiments, the system 200 proceeds to presenting to the user an instant preview for initial assessment. FIG. 4 illustrates a non-limiting example of the instant preview after the user uploads the relevant data file. Leveraging the insights from the correlation and autocorrelation analysis, users can select which items from their dataset will serve as features (i.e., inputs) and targets (i.e., outputs). For instance, as depicted in FIG. 4, users can drag and drop the selected items in a features box and a targets box using the data initialization component 201. Based on the user's selection, the system 200 operates to automate data preparation by generating additional features such as lags, moving averages, polynomial features, and logarithmic transformation in the data processing module 204. Additionally or alternatively, users can customize and add relevant features to enhance model performance.

Referring back to FIG. 2, the data preprocessing component 208 further includes a train and test split module 206 where automatic splitting between train data and test data takes place. The training data include all data except for recent data such as the last 6 months of available data. The testing data include the recent data such as the 6 months of available data at the end of dataframe (not including the training data) which is set aside for testing. In various embodiments, the system 200 facilitates its automated data preparation and feature engineering capabilities. The system 200 can generate additional features, ensuring that an AI/ML model will have a rich set of inputs. This automation may reduce the time and effort required for data preprocessing, allowing users to focus on building and optimizing their AI/ML models.

In various embodiments, the system 200 includes the artificial intelligence/machine learning (AI/ML) training and selection component 220. The component 220 includes an AI/ML models pool 221 connected to a processor 222, a training logic 223, a hyperparameter tuning module 224, a best model selection module 225, and an output module 226. The processor 222 is configured to communicate with the training logic 223, the hyperparameter tuning module 224, the best model selection module 225, and the output module 226, as depicted in FIG. 2. The training logic 223, upon execution by the processor 222, is configured to perform training individual models stored in the AI/ML models pool 221 in order to identify and select a best performing model for the given dataset (i.e., the user selected features and targets). The training logic 223, upon execution by the processor 221, is configured to train each of the models in the pool 221 for each target to optimize prediction accuracy. In various embodiments, the same training dataset apply to every model. As described above, the training data include all data except for recent data such as the last 6 months of available data. The testing data include the recent data such as the 6 months of available data at the end of dataframe (not including the training data) which is set aside for testing.

In various embodiments, the artificial intelligence/machine learning (AI/ML) training and selection component 220 includes a hyperparameter tuning module 224 which is a machine learning process that involves finding the best hyperparameters for a learning algorithm. Hyperparameters are model parameters that control the learning process and must be set before the learning process starts. The value of a hyperparameter cannot be estimated from the training data. Hyperparameter metrics are target variables that are optimized during hyperparameter tuning, such as model accuracy. When configuring the hyperparameter tuning, a goal can be defined for each metric and dictate whether to maximize or minimize the metric's value. For example, in the hyperparameter tuning for Random Forest, key hyperparameters include a number of trees (n_estimators), maximum tree depth (max_depth), and minimum samples required to split a node (min_samples_split). Common methods for tuning these hyperparameters include Grid Search, Random Search, Bayesian Search. Grid Search exhaustively searches through a specified subset of hyperparameter space, evaluating all possible combinations to identify the best configuration. Random Search, on the other hand, randomly samples from the hyperparameter space, which can be more efficient for large search spaces. Bayesian Search combines Grid Search and Random Search to apply dynamic learning methods for hyperparameter tuning. All methods typically use cross-validation to assess the performance of each hyperparameter combination, ensuring that the selected configuration generalizes well to unseen data.

In various embodiments, the best model selection module 225 is configured to use the testing data to select a final best model. The best AI/ML model of all AI/ML models is selected and hyperoptimization is applied. If performance is worse, a default model is the original best model without hyperparameter tuning.

In various embodiments, the best model selection module 225 is configured to provide detailed analytics and metrics, including feature-target correlations and model performance evaluations, with a focus on Mean Absolute Error. Mean Absolute Error (MAE) is an important metric to assess the performance of regression models. MAE provides a measure of average error, calculating the average absolute difference between predicted and actual values. In other words, MAE is used to assess the effectiveness of AI/ML models. Using MAE may be effective to reduce human errors and improve average consistency. MAE is useful in real-world scenarios where error costs are linear, such as demand forecasting or housing price estimation. It offers insights into average error sizes, making it a preferred metric for evaluating prediction quality based on absolute rather than relative error. By focusing on minimizing overall errors without disproportionately penalizing larger discrepancies, MAE promotes balanced learning. MAE is described above by way of example only and the present disclosure is not limited thereto. Other optimization criteria are available and can be used.

Based on the Mean Absolute Error, the best model selection module 225 is configured to select a best AI/ML model for the given dataset. Once the best AI/ML model is selected, the training logic 223, upon execution of the processor 222, is caused to execute a training on the best model. The training on the best model may be performed using the testing data. The best model selection module 225 is configured to map the selected best model to a user's declarative objective defined by the features and the targets. For instance, the best model section module 225 is coded to contain a dictionary object that stores relative models to each individual target.

In various embodiments, one best model is selected for each target and different best models can be used for different targets. Scope of forecasts is automated and the system 200 is customized to process a user data file of generalized features and targets.

In various embodiments, the artificial intelligence/machine learning (AI/ML) training and selection component 220 identifies and selects the best performing model for the given data, optimizing prediction accuracy by training individual models for each target. Detailed analytics and metrics, including feature-target correlations and model performance evaluations with a focus on Mean Absolute Error (MAE), provide users with a comprehensive understanding of the models' performance.

Additionally or alternatively, Mean Squared Error (MSE) can be used to select the best performing model. The present disclosure is not limited to MSE and other available optimization criteria can be used. MSE is a metric used in machine learning to measure the quality of a predictive model's predictions. MSE measures the average squared difference between the predicted and actual target values in a dataset. A lower MSE indicates that the model's predictions are closer to the true values, and therefore the model is performing better. A higher MSE indicates that the data points are more spread out from the mean. MSE can provide a meaningful indicator as it assesses how closely a model's predictions align with the ground truth. In some aspect, MSE penalizes errors on outliers more, whereas MAE improves average consistency.

In various embodiments, the training data is uploaded into the system 200 for training the AI/ML models pool and the best AI/ML model is selected as a result of the training. Then when running the system 200, the best model will be loaded and a user inputs live data to generate predictions using the best model.

In various embodiments, the output module 226 is configured to obtain a prediction or forecasting using the best model and presents the prediction or forecasting to the user interface component 230. In some embodiments, users can generate live predictions based on the trained models allowing for real-time forecasting.

In various embodiments, the user interface component 230 can be configured as a nocode interface which may enable users with no coding experience to build, test and deploy sophisticated AI models. The user interface component 230 can promote collaboration and efficiency across the organization, as more team members can contribute to and benefit from advanced forecasting capabilities.

The system 200 offers the user friendly and flexible tool, particularly the no-code interface designed to be accessible to users with no coding experience, thereby democratizing access to advanced machine learning capabilities. The intuitive user interface allows users to easily navigate through the data upload, feature selection, and model-building processes. The system 200 offers comprehensive data analysis tools, including correlation heatmaps and autocorrelation plots. These tools provide visual insights into the relationships between features and targets, aiding users in the features selection process and helping them understand the impact of each feature on the targets. The visual approach to data analysis makes the tool particularly user-friendly and effective.

As described above, the system 200 supports live predictions, allowing users to generate real-time forecast based on the trained models. Once the best model is trained, selected and uploaded, users can input live data to generate predictions using the best model. The live predictions, along with efficient preprocessing and modification of features and targets, ensures continuous improvement and adaptability to changing data conditions. By addressing the limitations of traditional forecasting methods and making advanced AI accessible to users, the system 200 aims to significantly enhance forecasting accuracy, reduce errors, and optimize resource allocation across organizations.

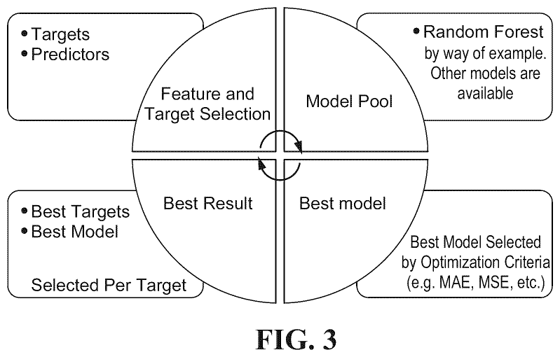

FIG. 3 depicts an illustrative embodiment of a model selection in accordance with various aspects described herein. For every feature and target, every AI/ML model is trained to determine the best model for a given dataset. By way of example only, AI/ML models include Random Forest. The Random Forest uses an ensemble of decision trees to make predictions and classification. The Random Forest creates many decision trees during training, each trained with a random subset of the data and a random subset of features. The output of the random forest is the average of the predictions from all trees for regression task. The Random Forest is described by way of example only but the present disclosure is not limited thereto. Other AI/ML models are available and can be used.

As depicted in FIG. 3, after every model is trained, a best model is selected based on predetermined criteria, such as the lowest MAE threshold, a lowest MSE threshold, etc. Using the best selected model, prediction will be performed, ensuring the best result including the best targets and the best predictors.

FIG. 4 depicts an exemplary, non-limiting embodiment of a first user interface 400 in accordance with various aspects described herein. The first user interface 400 includes a user input box 402 which allows a user to drag and drop a data file in various formats. Additionally, the user input box 402 also allows a user to brows a local storage drive to select file(s). The first user interface 400 illustrates “Volume Forecasting Application” as a starting interface. Once the dataset is provided by a user, an initial assessment view 405 is immediately presented to a user. The initial assessment view 405 shows features and targets based on the dataset.

In various embodiments, the first user interface 400 enables a user to drag and drop features and targets shown in the initial assessment view 405 in a features selection box 408 and a targets selection box 410.

FIG. 5 depicts an exemplary, non-limiting embodiment of a second user interface 500 in accordance with various aspects described herein. The second user interface 500 illustrates correlation heatmaps and autocorrelation plots. The second user interface 500 depicts one example of comprehensive data analysis tools offered by the systems and methods for generating a machine learning driven regressive forecasting model optimized for a user declaration based dataset in accordance with various aspects of the present disclosure. These tools, including the example depicted in FIG. 5, provide visual insights into the relationships between features and targets, aiding users in the features selection process and helping users understand the impact of each feature on the targets. The visual approach to data analysis makes the system and method user-friendly and effective.

FIG. 6 depicts an exemplary, non-limiting embodiment of a third user interface 600 in accordance with various aspects described herein. The third user interface 600 illustrates autocorrelation functions (ACFs) for activities. Autocorrelation analysis is an important step in time series forecasting. The autocorrelation analysis helps detect patterns and check for randomness. As depicted in FIG. 6, ACF generates plots that are very important in finding relevant values for Autoregressive (AR) and Moving Average (MA) models. The ACF may be used to determine previous lagged values (such as past rates) to also predict future values. The magnitude of ACF plots indicates how strong the correlation is, ranging from 0 (no correlation) to 1 (perfect positive correlation) or −1 (negative correlation). The third user interface 600 further illustrates training and testing data preview. Training data and test data are both used in machine learning for different purposes. The training data are used to train a machine learning model to predict outcomes. AI/ML models learn patterns and relationships in the data to make predictions on new data. The test data are used to evaluate the performance of a trained model. The purpose of the test data is to assess how well AI/ML models generalize to new data. A balanced dataset with a proper split between training and test data can help reduce the risk of overfitting or underfitting and achieve a highly accurate model. For instance, a common split is 80% of the data for training and 20% for testing. As described above, the system 200 uses the training and test data split using particular time frames of available data.

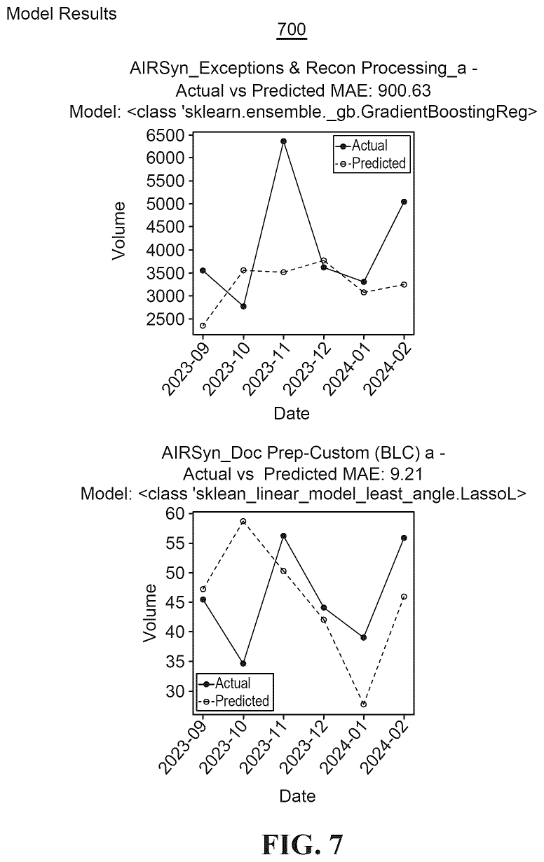

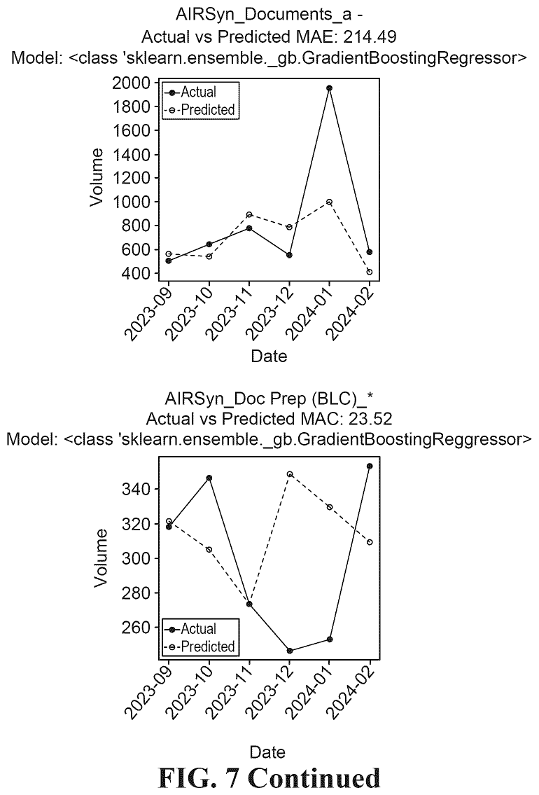

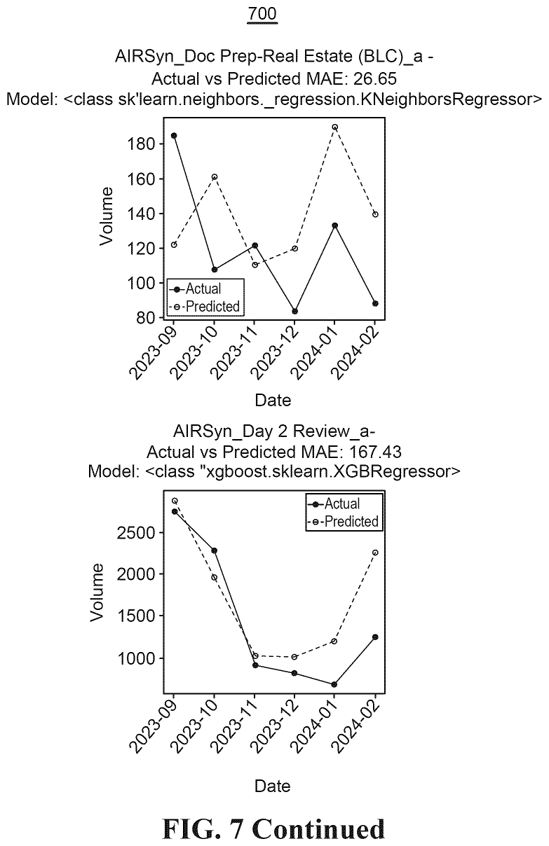

FIG. 7 depicts an exemplary, non-limiting embodiment of a fourth user interface 700 in accordance with various aspects described herein. The fourth user interface 700 illustrates model results in several graphical representation forms. The purpose of FIG. 7 is to display an informative example of individual model performances in the real time setting. It also showed the visual example of the model performances against actual values which is blue lines. For each individual activity, it would display the error measurements as well as the best selected model.

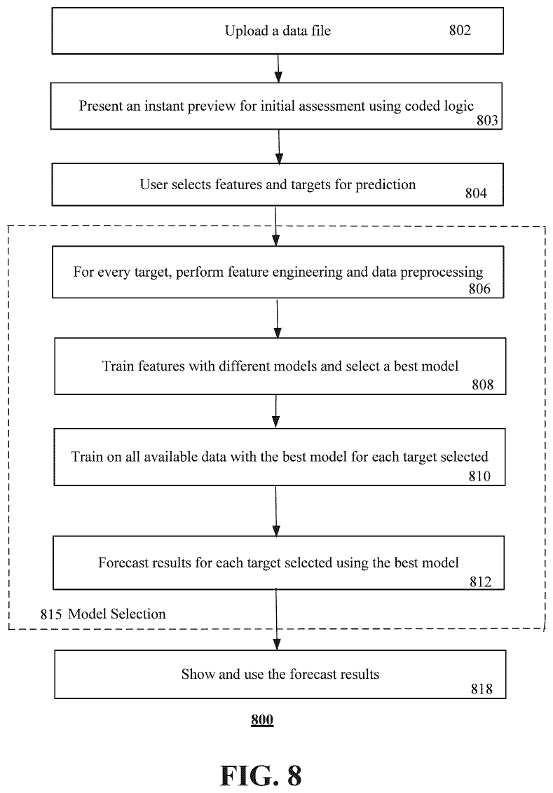

FIG. 8 depicts an illustrative embodiment of a method 800 for generating a machine learning driven regressive forecasting model optimized using a user declared dataset in accordance with various aspects described herein. The method 800 includes uploading a data file (Step 802), and based on the uploaded data file, presenting an instant preview for initial assessment using coded logic (Step 803). For instance, automated feature selection is coded and performed with respect to the uploaded data file. A user selects features and targets for prediction based on the presented instant preview (Step 804). The method 800 further includes a model selection phase 815 which includes, for every target, perform feature engineering and data preprocessing (Step 806), training features with different models and selecting the best model (Step 808), training on all available data with the best model for the target selected (Step 810), forecasting results for the targets selected using the best model (Step 812). The method 800 includes showing and using the forecasting result (Step 818).

In the model selection phase 815, the user has selected the features and the targets for prediction in Step 804, and for the selected target, feature engineering and data preprocessing (such as data cleaning, and encoding categorical values, feature scaling, polynomial features, logarithmic features, and Training/Test data split) are performed in Step 806. With training data, AI/ML models in the models pool are trained and based on the training results, a best model is selected in Step 808. With respect to the target selected, the step 810 performs training, with the best model, on all available data. Once the best model is available and loaded, then the user can perform forecasting based on the selected target and obtain forecast results (Step 812). The forecast results are delivered to the user via a user interface component and displayed in various forms and techniques based on available configurations.

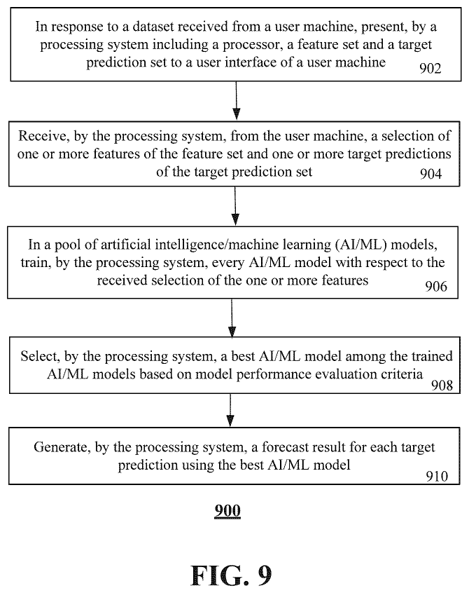

FIG. 9 depicts an illustrative embodiment of a method 900 for generating a machine learning driven regressive forecasting model in accordance with various aspects described herein. The method 900 includes presenting, by a processing system including a processor, a feature set and a target prediction set to a user interface of a user machine (Step 902), receiving, by the processing system, from the user machine, one or more features of the feature set and one or more target predictions of the target prediction set (Step 904), in a pool of artificial intelligence/machine learning (AI/ML) models, training, by the processing system, every AI/ML model with respect to the received selection of the one or more features (Step 906), selecting, by the processing system, a best AI/ML model among the trained AI/ML models based on model performance evaluation criteria (Step 908), and generating, by the processing system, a forecast result for each target prediction using the best AI/ML model (Step 910).

In various embodiments, the method 900 further includes training, by the processing system, the selected best AI/ML model with respect to the selected target. The method 900 also includes receiving, by the processing system, a dataset from the user machine, and preprocessing, by the processing system, the received dataset to determine the feature set and the target prediction set. The method 900 also includes loading, by the processing system, the selected and trained best AI/ML model to generate the forecast result. The method 900 includes transmitting, by the processing system, the forecast result to the user interface of the user machine for display in a plurality of different representations. The method 900 includes automating, by the processing system, data preparation based on the received dataset by generating additional features, wherein the additional features include lags, moving averages, polynomial features, logarithmic transformations, or a combination thereof. The method 900 includes enabling, by the processing system, the user machine to customize and add one or more relevant features to the feature set. The method 900 includes storing, by the processing system, the model performance evaluation criteria in forms of analytics and metrics focusing on Mean Absolute Error.

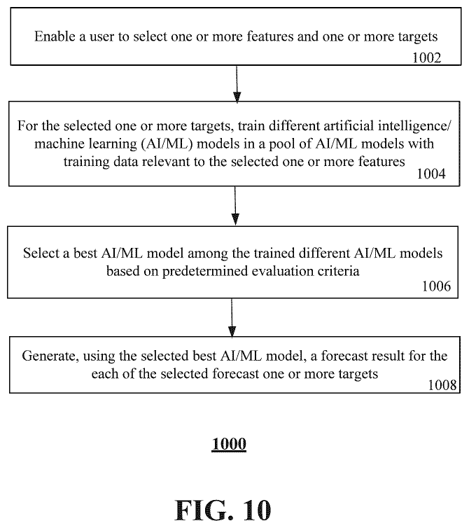

FIG. 10 depicts an illustrative embodiment of another method 1000 for generating a machine learning driven regressive forecasting model in accordance with various aspects described herein. The method 1000 includes enabling a user to select one or more features, one or more targets (Step 1002), training different artificial intelligence/machine learning (AI/ML) models in a pool of AI/ML models with training data relevant to the selected one or more features and the selected one or more targets (Step 1004), selecting a best AI/ML model among the trained different AI/ML models based on predetermined evaluation criteria (Step 1006), and generating, using the selected best AI/ML model, a forecast result for each of the selected one or more targets (Step 1008). The training the different AI/ML models (Step 1004) further includes training each and every model in the pool of AI/ML models to select the best model. The selecting the best model (Step 1006) further includes selecting one best model for each target selected by the user and different best models are selected for different targets.

In various embodiments, the method 1000 further includes generating a graphical user interface configured to allow the user to: drag and drop or upload a data file; drag and drop the selected one or more features and the selected one or more targets; and customize and add additional relevant features. The method 1000 also includes generating correlation heatmaps and autocorrelation plots between the one or more features and the one or more targets for display on the graphical user interface, and transmitting the generated forecast result for display on the graphical user interface.

In various embodiments, the method 1000 further includes loading the selected and trained best AI/ML model, and in response to input live data provided by the user, generating near real time forecast results using the selected and trained best AI/ML model. The method 1000 also includes testing the plurality of AI/ML models under particular data constraints, wherein the particular data constraints include limited time intervals of data and a size of data smaller than a predetermined row counts threshold associated with the limited time intervals of data. The method 1000 also includes automating splitting between training data and testing data, uploading the training data to train the plurality of AI/ML models, and utilizing the testing data in the selection of the best AI/ML model.

As described in the above embodiments, the systems and methods enable users to build, optimize, and deploy robust forecasting machine learning models without needing to write code. The systems and methods are designed to build high-performance regressive forecasting models, specifically for environments with monthly data intervals and small datasets, using an intuitive no-code interface. The systems and methods are configured to perform data upload and management, correlation and autocorrelation analysis, feature and target selection, and data preparation and feature engineering. Users can upload datasets in CSV format and get an immediate preview for initial assessment. The systems and methods generate and display correlation heatmaps and autocorrelation plots, providing visual insights into relationships between features and targets. Leveraging insights from the correlation and autocorrelation analysis, users can select which columns from their dataset will serve as features and which will be targets by way of example.

As described in the above embodiments, the systems and methods are configured to automate data preparation by generating additional features such as lags, moving averages, polynomial features, and logarithmic transformations. Users can also customize and add relevant features to enhance model performance. Detailed analytics and metrics are provided, including feature-target correlations and model performance evaluations, with a focus on Mean Absolute Error. Users can generate live predictions based on trained models allowing for real-time forecasting. The systems and methods facilitates efficient preprocessing and modification of features and targets for continuous improvement. No code interface is provided to enable users with no coding experience to build, test, and deploy machine learning models. A user-friendly interface may require no coding, making it accessible to non-technical users. This simplicity allows for quick adoption and ease of use across different business units.

The systems and methods are scaled across various business lines that require monthly forecasting. The systems and methods can be easily adapted to different data structures and forecasting needs, making it a versatile tool for a wide range of applications. The systems and methods can be implemented across multiple sectors, including finance, operations, and public sector applications. The systems and methods provide a flexible solution for organizations needing accurate forecasting based on limited, monthly interval data. The systems and methods are designed to meet the requirements of regulated industries, ensuring compliance with government regulations. This makes it suitable for use in government-related forecasting needs, where adherence to strict legal standards is essential. The systems and methods represent a significant leap in the field of forecasting, offering unique solution tailored to the challenges of small data environments. By integrating small data optimization with a declarative AI framework, the systems and methods automate complex processes while ensuring high accuracy. Ease of use and adaptability across various sectors make it a versatile tool for businesses and government agencies alike.

While for purposes of simplicity of explanation, the respective processes are shown and described as a series of blocks in FIGS. 8 through 10, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

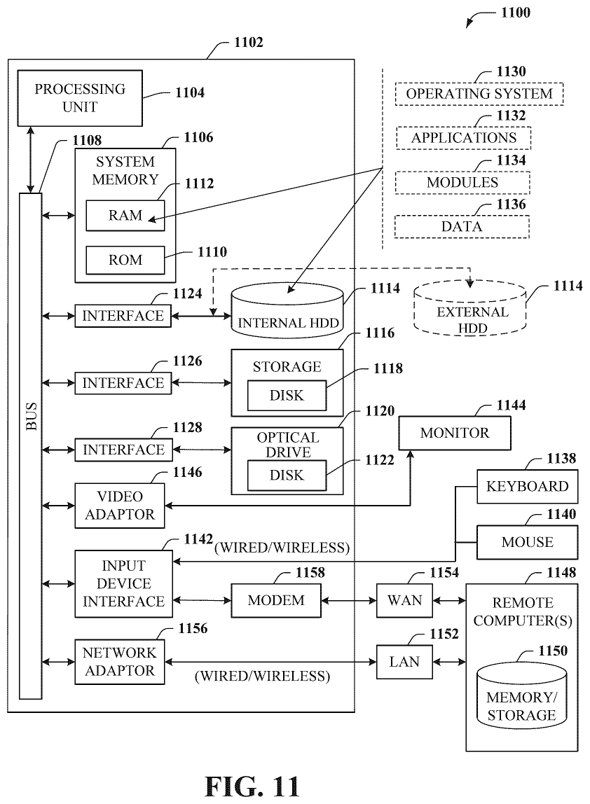

Turning now to FIG. 11, there is illustrated a block diagram of a computing environment in accordance with various aspects described herein. In order to provide additional context for various embodiments of the embodiments described herein, FIG. 11 and the following discussion are intended to provide a brief, general description of a suitable computing environment 1100 in which the various embodiments of the subject disclosure can be implemented. For example, computing environment 1100 can facilitate in whole or in part systems and methods for generating a machine learning driven regressive forecasting model optimized for a user declared lightweight dataset.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 11, the example environment can comprise a computer 1102, the computer 1102 comprising a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multiprocessor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 comprises ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also comprise a high-speed RAM such as static RAM for caching data.

The computer 1102 further comprises an internal hard disk drive (HDD) 1114 (e.g., EIDE, SATA), which internal HDD 1114 can also be configured for external use in a suitable chassis (not shown), a storage medium 1116, (e.g., to read from or write to a removable storage medium 1118) and an optical disk drive 1120, (e.g., reading a CD-ROM disk 1122 or, to read from or write to other high-capacity optical media such as the DVD). The HDD 1114, storage medium 1116 and optical disk drive 1120 can be connected to the system bus 1108 by a hard disk drive interface 1124, a drive interface 1126 and an optical drive interface 1128, respectively. The hard disk drive interface 1124 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 1112, comprising an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) can comprise a microphone, an infrared (IR) remote control, a joystick, a game pad, a stylus pen, touch screen or the like. These and other input devices are often connected to the processing unit 1104 through an input device interface 1142 that can be coupled to the system bus 1108, but can be connected by other interfaces, such as a parallel port, an IEEE 1394 serial port, a game port, a universal serial bus (USB) port, an IR interface, etc.

A monitor 1144 or other type of display device can be also connected to the system bus 1108 via an interface, such as a video adapter 1146. It will also be appreciated that in alternative embodiments, a monitor 1144 can also be any display device (e.g., another computer having a display, a smart phone, a tablet computer, etc.) for receiving display information associated with computer 1102 via any communication means, including via the Internet and cloud-based networks. In addition to the monitor 1144, a computer typically comprises other peripheral output devices (not shown), such as speakers, printers, etc.

The computer 1102 can operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically comprises many or all of the elements described relative to the computer 1102, although, for purposes of brevity, only a remote memory/storage device 1150 is illustrated. The logical connections depicted comprise wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the LAN 1152 through a wired and/or wireless communication network interface or adapter 1156. The adapter 1156 can facilitate wired or wireless communication to the LAN 1152, which can also comprise a wireless AP disposed thereon for communicating with the adapter 1156.

When used in a WAN networking environment, the computer 1102 can comprise a modem 1158 or can be connected to a communications server on the WAN 1154 or has other means for establishing communications over the WAN 1154, such as by way of the Internet. The modem 1158, which can be internal or external and a wired or wireless device, can be connected to the system bus 1108 via the input device interface 1142. In a networked environment, program modules depicted relative to the computer 1102 or portions thereof, can be stored in the remote memory/storage device 1150. It will be appreciated that the network connections shown are example and other means of establishing a communications link between the computers can be used.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

We claim:

1. A method, comprising:
in response to a dataset received from a user machine, presenting, by a processing system including a processor, a feature set and a target prediction set to a user interface of a user machine;
receiving, by the processing system, from the user machine, a selection of one or more features of the feature set and one or more target predictions of the target prediction set;
in a pool of artificial intelligence/machine learning (AI/ML) models, training, by the processing system, every AI/ML model with respect to the received selection of the one or more features;
selecting, by the processing system, a best AI/ML model among the trained AI/ML models based on model performance evaluation criteria; and
generating, by the processing system, a forecast result for each target prediction using the best AI/ML model.

2. The method of claim 1, further comprising:
training, by the processing system, the selected best AI/ML model with respect to each of the selected one or more target predictions.

3. The method of claim 1, further comprising:
receiving, by the processing system, a dataset from the user machine; and
preprocessing, by the processing system, the received dataset to determine, the feature set and the target prediction set.

4. The method of claim 1, further comprising:
loading, by the processing system, the selected best AI/ML model to generate the forecast result.

5. The method of claim 1, comprising:
transmitting, by the processing system, the forecast result to the user interface of the user machine for display in a plurality of different graphical representations.

6. The method of claim 1, comprising:
receiving, by the processing system, a dataset from the user machine; and
automating, by the processing system, data preparation based on the received dataset by generating additional features, wherein the additional features include lags, moving averages, polynomial features, logarithmic transformations, or a combination thereof.

7. The method of claim 6, comprising:
enabling, by the processing system, the user machine to customize and add one or more relevant features to the feature set.

8. The method of claim 1, comprising:
storing, by the processing system, the model performance evaluation criteria in forms of analytics and metrics focusing on Mean Absolute Error.

9. A non-transitory machine-readable medium, comprising executable instructions that, when executed by a processing system including a processor, facilitate performance of operations, the operations comprising:
enabling a user to select one or more features and one or more targets;
for the selected one or more targets, training different artificial intelligence/machine learning (AI/ML) models in a pool of AI/ML models with training data relevant to the selected one or more features; and
selecting a best AI/ML model among the trained different AI/ML models based on predetermined evaluation criteria; and
generating, using the selected best AI/ML model, a forecast result for each of the selected one or more targets.

10. The non-transitory machine-readable medium of claim 9, wherein the operations further comprise:
receiving a dataset provided by the user; and
performing automated data preparation of the received dataset by running data cleaning and data preprocessing.

11. The non-transitory machine-readable medium of claim 9, wherein the operations further comprise generating a graphical user interface configured to allow the user to:
drag and drop or upload a data file;
drag and drop the selected one or more features and the selected one or more targets; and
customize and add additional relevant features.

12. The non-transitory machine-readable medium of claim 11, wherein the operations further comprise:
generating correlation heatmaps and autocorrelation plots between the selected one or more features and the selected one or more targets for display on the graphical user interface; and
transmitting the generated forecast result for display on the graphical user interface.

13. The non-transitory machine-readable medium of claim 9, wherein the operations further comprise:
loading the selected best AI/ML model; and
in response to input live data provided by the user, generating near real time forecast results using the selected best AI/ML model.

14. The non-transitory machine-readable medium of claim 11, wherein the operations further comprise:
automating data preparation of the data file by generating additional features, wherein the additional features include lags, moving averages, polynomial features, logarithmic transformations, or a combination thereof.

15. A device, comprising:
a processing system including a processor; and
a memory that stores executable instructions that, when executed by the processing system, facilitate performance of operations, the operations comprising:
in response to datasets provided by a user, automating correlation between a set of features and a set of targets and populating the correlation for display on a user machine;
receiving, from the user machine, a selection of one or more features in the set of features, and a selection of one or more targets in the set of targets;
automating data preparation of the datasets provided by the user;
training a plurality of artificial intelligence/machine learning (AI/ML) models in a pool of AI/ML models with the selected one or more features;
selecting a best AI/ML model among the trained AI/ML models based on predetermined model performance criteria;
training the selected best AI/ML model with respect to each of the selected one or more targets; and
generating, using the selected and trained AI/ML best model, forecast results for each of the selected one or more targets.

16. The device of claim 15, wherein the training the plurality of AI/ML models further comprises training each model in the pool of AI/ML models to select the best AI/ML model.

17. The device of claim 15, wherein the operations further comprise:
loading, by the processing system, the trained selected best AI/ML model; and
in response to input live data provided by the user machine, generating near real time forecast results using the trained selected best AI/ML model.

18. The device of claim 15, wherein the operations further comprise testing the plurality of AI/ML models under particular data constraints, wherein the particular data constraints include limited time intervals of data and a size of data smaller than a predetermined size threshold associated with the limited time intervals of data.

19. The device of claim 15, wherein the selecting the best AI/ML model further comprise selecting one best model for each target selected by the user, wherein different best models are selected for different targets.

20. The device of claim 15, wherein the operations further comprise:
automating splitting between training data and testing data;
uploading the training data to train the plurality of AI/ML models; and
utilizing the testing data in the selection of the best AI/ML model.
